(19) United States
(12) Patent Application Publication
(10) Pub. No.: US 2006/0114974 A1
(43) Pub. Date: Jun. 1, 2006

(54) Normalized least mean square chip-level equalization advanced diversity receiver

(75) Inventors: Ariela Zeira, Huntington, NY (US); Philip J. Pietraski, Huntington Station, NY (US); Jung-Lin Pan, Selden, NY (US); Mihaela Beluri, Glen Cove, NY (US); Rui Yang, Greenlawn, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/210,949

(22) Filed: Aug. 24, 2005

Related U.S. Application Data
(60) Provisional application No. 60/625,648, filed on Nov. 5, 2004.

(51) Int. Cl. H04B 1/707; H04B 1/10

(52) U.S. Cl. 375/148; 375/350

(57) ABSTRACT

A receiver which includes at least one equalizer filter and a tap coefficients generator for implementing receive diversity. The equalizer filter processes a signal derived from signals received by a plurality of antennas. In one embodiment, sample data streams from the antennas are merged into one sample data stream. The merged sample data stream is processed by a single extended equalizer filter, whereby filter coefficients are adjusted in accordance with a joint error signal. A filter coefficient correction term used by the equalizer filter is generated by the tap coefficients generator using a normalized least mean square (NLMS) algorithm. In another embodiment, a plurality of equalizer filters are utilized, whereby each equalizer receives a sample data stream from a specific one of the antennas. In yet another embodiment, the sample data streams are combined after being processed by a plurality of matched filters based on respective estimated channel impulse responses.

### CROSS REFERENCE TO RELATED APPLICATION

This application claims the benefit of U.S. provisional application No. 60/625,648 filed on Nov. 5, 2004, which is incorporated by reference as if fully set forth.

### FIELD OF THE INVENTION

The present invention is related to a wireless communication system which employs receiver diversity. More particularly, the present invention relates to receive diversity techniques for a normalized least mean square (NLMS) chip-level equalization (CLE) receiver.

### BACKGROUND

Chip-level equalizers are suitable candidates for advanced receiver systems, such as those used in wireless transmit/receive units (WTRUs) and base stations. An NLMS-based CLE receiver offers superior performance for high data rate services such as high speed downlink packet access (HSDPA) over a Rake receiver. A typical NLMS receiver consists of an equalizer filter and an NLMS algorithm. The equalizer filter is typically a finite impulse response (FIR) filter.

The NLMS algorithm is used as the tap coefficients generator. It generates appropriate tap coefficients used by the equalizer filter and updates them appropriately and iteratively in a timely manner. Typically, tap coefficients generation includes the error signal computation, vector norm calculation and leaky integration to generate and update the tap coefficients.

Although the NLMS CLE has been well proven for the single antenna receiver, an extension of the NLMS algorithm for receiver diversity has not been provided. A simple extension would be to provide one NLMS CLE for each antenna and combine the results of each. However, this is unnecessarily suboptimal.

### SUMMARY

The present invention is related to a receiver which includes at least one equalizer filter and a tap coefficients generator for implementing receive diversity. The equalizer filter processes a signal derived from signals received by a plurality of antennas. In one embodiment, sample data streams from the antennas are merged into one sample data stream. The merged sample data stream is processed by a single extended equalizer filter, whereby filter coefficients are adjusted in accordance with a joint error signal. A filter coefficient correction term used by the equalizer filter is generated by the tap coefficients generator using an NLMS algorithm. In another embodiment, a plurality of equalizer filters is utilized, whereby each equalizer receives a sample data stream from a specific one of the antennas. In yet another embodiment, the sample data streams are combined after being processed by a plurality of matched filters based on respective estimated channel impulse responses.

### BRIEF DESCRIPTION OF THE DRAWINGS

A more detailed understanding of the invention may be had from the following description, given by way of example and to be understood in conjunction with the accompanying drawings wherein:

FIG. 1 is a block diagram of an exemplary NLMS CLE receiver configured in accordance with a first embodiment of the present invention;

FIG. 2 is a block diagram of an exemplary NLMS CLE receiver configured in accordance with a second embodiment of the present invention;

FIG. 3 is a block diagram of a simplified version of the NLMS CLE receiver of FIG. 2; and

FIG. 4 is a block diagram of an exemplary NLMS CLE receiver configured in accordance with a third embodiment of the present invention.

### DETAILED DESCRIPTION OF THE PREFERRED EMBODIMENTS

The preferred embodiments will be described with reference to the drawing figures where like numerals represent like elements throughout.

Hereafter, the terminology “WTRU” includes but is not limited to a user equipment (UE), a mobile station, a laptop, a personal data assistant (PDA), a fixed or mobile subscriber unit, a pager, or any other type of device capable of operating in a wireless environment. When referred to hereafter, the terminology “base station” includes but is not limited to an access point (AP), a Node-B, a site controller or any other type of interfacing device in a wireless environment.

The features of the present invention may be incorporated into an integrated circuit (IC) or be configured in a circuit comprising a multitude of interconnecting components.

Hereafter, the present invention will be explained with reference to an NLMS algorithm. However, it should be noted that any other adaptive equalization algorithm may be utilized.

Hereafter, the present invention will be explained with reference to methods of receiver diversity for an NLMS algorithm. However, it should be noted that any type of adaptive equalization or filtering, such as least mean square (LMS), Griffith's algorithm, channel estimation based NLMS (CE-NLMS), and other iterative or recursive algorithms may be used.

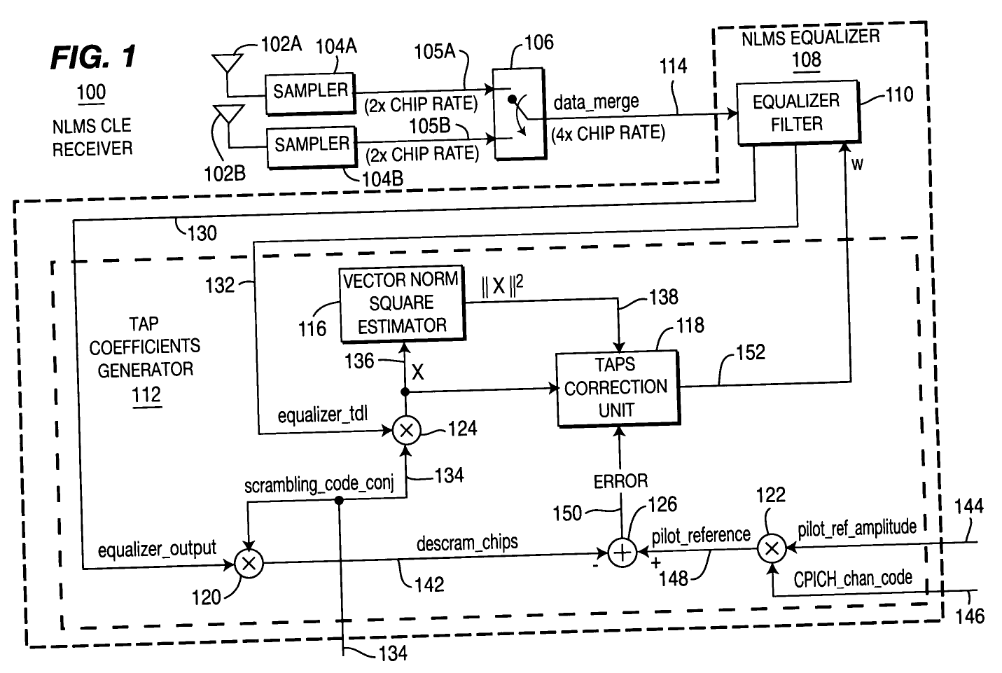

FIG. 1 is a block diagram of an exemplary NLMS CLE receiver 100 configured in accordance with a first embodiment of the present invention. The NLMS CLE receiver 100 is a joint processing NLMS receiver which uses a single equalizer filter. The NLMS CLE receiver 100 includes a plurality of antennas 102A, 102B, a plurality of samplers 104A, 104B, a multiplexer 106 and an NLMS equalizer 108. The NLMS equalizer 108 includes an equalizer filter 110 and a tap coefficients generator 112.

Signals received by the antennas 102A, 102B are respectively input into the samplers 104A, 104B for generating respective sample data streams 105A, 105B which are sampled at two times (2×) the chip rate. The sample data streams 105A, 105B are merged by the multiplexer 106 into a single sample data stream 114 which is input into the equalizer filter 110 of the NLMS equalizer 108. Since samples occur at twice the chip rate on each of the sample data streams 105A, 105B, samples will occur at 4 times (4×) the chip rate on the sample data stream 114. Each sample that occurs on the sample data stream 114 originated from either sample data stream 105A or 105B. The effective rate of the equalizer filter 106 is four times (4×) the chip rate.

Although FIG. 1 illustrates the NLMS CLE receiver 100 as being capable of sampling signals received from two (2) antennas at twice (2×) the chip rate, it should be noted that the NLMS CLE receiver 100 may comprise any number of antennas and the signals received by the antennas may be sampled at any desired rate.

The equalizer filter 110 comprises a plurality of taps with filter coefficients. A FIR filter may be utilized as the equalizer filter 110. The number of taps in the equalizer filter 110 may be optimized for specific multipath channels of different power-delay profiles and vehicle speeds. The tap coefficients generator 112 includes a vector norm square estimator 116, a taps correction unit 118, multipliers 120, 122, 124, and an adder 126.

The equalizer filter 110 outputs an equalizer output signal 130, which is a chip rate signal. The equalizer output signal 130 is multiplied with a scrambling code conjugate signal 134 via the multiplier 120 to generate a descrambled equalizer output signal 142, (which is an estimate of the unscrambled transmitted chips). The descrambled equalizer output signal 142 is input to a first input of the adder 126. The equalizer output signal 130 is determined based on an equalizer tapped delay line (TDL) signal 132 and a taps correction signal 152.

A pilot amplitude reference signal 144 is used to adjust the average output power of the equalizer 108 by changing the amplitude of a pilot reference signal 148, which is generated by the multiplier 122 which multiplies the pilot reference amplitude signal 144 with a scaled pilot, (i.e., common pilot channel (CPICH)), channelization code 146. The pilot reference signal 148 is input to a second input of the adder 126. The descrambled equalizer output signal 142 is subtracted from the pilot reference signal 148 by the adder 126 to generate an error signal 150 which is input to a first input of the taps correction unit 118. The external signals 134, 144 and 146 are configured and generated based on information signaled from higher layers.

The equalizer TDL signal 132 is multiplied with the scrambling code conjugate signal 134 via the multiplier 124 to generate a vector signal 136 having a value X, which is a descrambled version of signal 132. The vector signal 136 is input to the vector norm square estimator 116 and to a second input of the taps correction unit 118. The vector norm square estimator 116 generates a signal 138 having a value which is equal to ∥X∥², (i.e., the norm squared of the value X of the vector signal 136, or equivalently the equalizer TDL signal 132). The vector norm square estimator 116 outputs the signal 138 to a third input of the taps correction unit 118. Based on the signals 136, 138 and 150, the taps correction unit 118 outputs the taps correction signal 152 having a value, w, which is input to the equalizer filter 110.

The taps correction signal 152 represents the tap values used by the equalizer filter 110. At a given time, the next value w of the taps correction signal 152 is computed by adding to the current value of the taps correction signal 152, (possibly weighted by a leakage factor), the product of the normalized signal, (signal 130 divided by signal 140), and the error signal 150 and a step size parameter defined within the taps correction unit 118. A more detailed mathematical description is provided below.

The taps correction signal 152 is updated by the taps correction unit 118 as follows:

$${\vec{w}}_{n} = α \cdot {\vec{w}}_{n - 1} + μ \frac{{\vec{x}}^{H}}{{‖ \vec{x} ‖}^{2} + ɛ} \cdot error , \qquad Equation ( 1 )$$

where \vec{w}ₙ is a weight vector defined for the equalizer filter 110, \vec{x}, \vec{x}ₙ^{H} are vectors based on the samples received from the antennas 102A, 102B, μ, α, ε are parameters chosen to control the adaptation step size, tap leakage, and to prevent division by zero (or near zero) numbers respectively. ε is a small number used to prevent from dividing by zero. The leakage parameter α (alpha) is a weighting parameter typically not greater than 1. The step size parameter μ is a scale factor on the error. The equalizer filter 110 is simply a FIR structure that computes the inner product of w and X, <w,X>. The result of the inner product is the equalizer output signal 130.

The present invention implements receive diversity in conjunction with an adaptive equalizer, which greatly improves the receiver performance. Ajoint equalizer filter coefficient vector adaptation scheme in accordance with the present invention is described below.

A joint weight vector \vec{w}_{n,joint} is defined for the equalizer filter as a union of multiple component weight vectors. Each component weight vector corresponds to data collected by a different antenna. Any permutation of elements from component vectors may comprise the joint weight vector so long as the permutation properly reflects the order in which data enters the joint NLMS equalizer. As these are mathematically equivalent, the permutation may be chosen for notational convenience. For example, for two antennas, the joint weight vector \vec{w}_{n,joint} can be defined as follows:
\vec{w}_{n,joint}=[\vec{w}_{n,1}^{T}, \vec{w}_{n,2}^{T}]^{T}, Equation (2)
where ( )^{T} denotes a transpose operation. The total number of taps of the equalizer filter is denoted by L. \vec{w}_{n,joint} is a column vector.

For the chosen notation in Equation (2), the notation for the joint update vector \vec{x}_{n,joint} is defined as follows:
\vec{x}_{n,joint}=[\vec{x}ₙ¹, \vec{x}ₙ²], Equation (3)
where \vec{x}ₙ¹, \vec{x}ₙ² are vectors based on the samples received from antenna 1 and antenna 2, respectively. \vec{x}_{n,joint} is a row vector.

The filter coefficient adaptation for the joint NLMS equalizer can then be processed in a usual way for an NLMS equalizer. For example, the updated coefficient vector can be obtained as follows:

$${\vec{w}}_{n + 1 , joint} = α \cdot {\vec{w}}_{n , joint} + μ \frac{{\vec{x}}_{n , joint}^{H}}{{‖ {\vec{x}}_{n , joint} ‖}^{2} + ɛ} ( d [ n ] - {\vec{x}}_{n , joint} {\vec{w}}_{n , joint} ) , \qquad Equation ( 4 )$$

where ( )^{H} denotes a transpose conjugate operation, d[n] is the reference signal for NLMS and ε is a small number used to prevent from dividing by zero. The parameter α is a weighting parameter and μ is a scale factor of error signal. The μ can be estimated based on the vehicle speed and signal-to-interference and noise ratio (SINR) and interpolated to obtain a continuous estimation.

For pilot-directed NLMS, d[n] can be a pilot signal, training signal, or other known pattern signals, either despread signal with pre-determined despreading factors or non-despread signal. Similarly for data-directed NLMS, d[n] can be fully-, partially- or non-despread data symbols. The tap correction terms \vec{Δ}ₙ are computed as follows:

$${\vec{Δ}}_{n} = μ \frac{{\vec{x}}_{n , joint}^{H}}{{‖ {\vec{x}}_{n , joint} ‖}^{2} + ɛ} \cdot {e}_{n , joint} , \qquad Equation ( 5 )$$

where the factor e_{n,joint} is a joint error signal and is computed by subtracting the equalizer filter output from the reference signal d[n] as follows:
e_{n,joint}=d[n]−\vec{x}_{n,joint}\vec{w}_{n,joint} . Equation (6)

The new tap coefficients for the next iteration are obtained by adding the tap correction terms \vec{Δ}ₙ to the (weighted) tap coefficients of the previous iteration. The weighting mechanism can be characterized by a parameter α (alpha) formulated as follows:
\vec{w}ₙ₊₁=α·\vec{w}ₙ+\vec{Δ}ₙ. Equation (7)

The joint tap update vector in Equation (4) is simply obtained by substituting the joint weight vector \vec{w}_{n,joint} for \vec{w}ₙ and the joint update vector \vec{x}_{n,joint} for \vec{x}ₙ into the standard NLMS equation. Equation (4) uses the joint equalizer output and subtracts it from the desired signal or pilot signal to produce joint estimation error. The vector norm square for the input signal is a joint vector norm square. The joint estimation error together with the complex conjugate of input signal, p and vector norm square of input signal produces a correction term which is added to the tap-weight vector of the iteration n to produce the tap-weight vector of iteration n+1, the updated tap-weight vector.

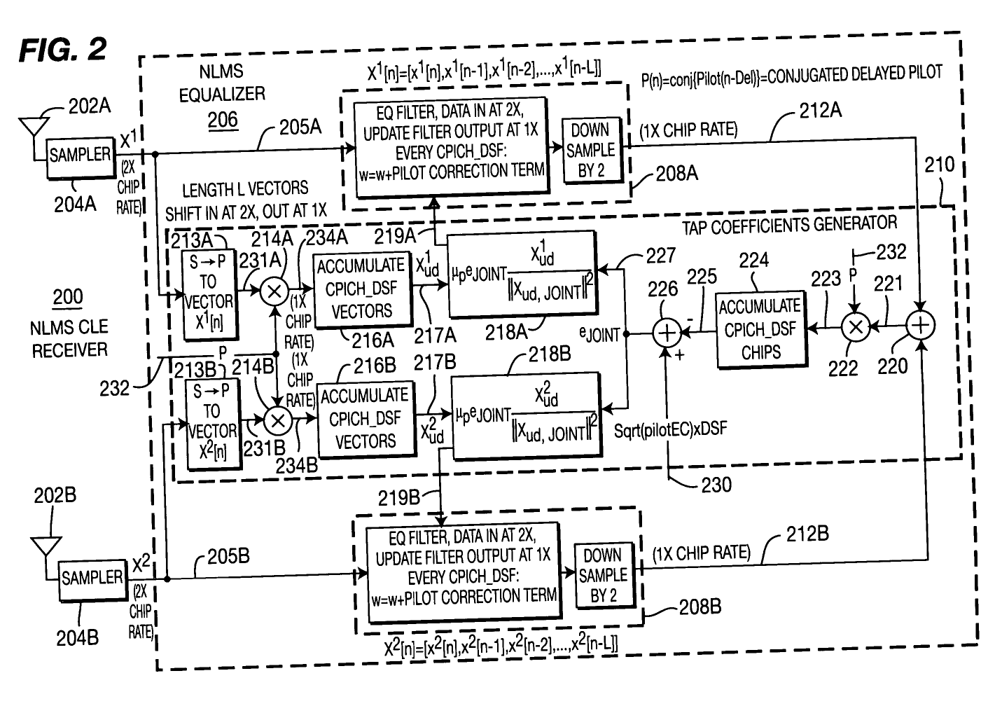

FIG. 2 is a block diagram of an exemplary NLMS CLE receiver 200 configured in accordance with a second embodiment of the present invention. The NLMS CLE receiver 200 is a despread pilot-directed joint processing NLMS receiver which uses multiple equalizers. The NLMS CLE receiver 200 includes a plurality of antennas 202A, 202B, a plurality of samplers 204A, 204B and an NLMS equalizer 206. The NLMS equalizer 206 includes a plurality of equalizer filters 208A, 208B and a tap coefficients generator 210. Signals received by the antennas 202A, 202B are respectively input into the samplers 204A, 204B, which generate respective sample data streams 205A, 205B, (X¹, X²).

Although FIG. 2 illustrates the NLMS CLE receiver 200 as being capable of sampling signals received from two (2) antennas at twice (2×) the chip rate, it should be understood that the NLMS CLE receiver 200 may comprise any number of antennas and equalizer filters, and the signals received by the antennas may be sampled at any desired rate.

The samples data streams 205A, 205B from the samplers 204A, 204B enter the corresponding equalizer filters 208A, 208B and the tap coefficients generator 210. The sample data streams 205A, 205B are processed and down-sampled, (in this example, down-sampled by 2), by the equalizer filters 208A, 208B to generate equalized signals 212A, 212B at one times (1×) the chip rate.

The tap coefficients generator 210 includes serial-to-parallel (S→P) to vector converters 213A, 213B, multipliers 214A, 214B and 222, vectors accumulators 216A, 216B, correction term generators 218A, 218B, adders 220 and 226, and a chip accumulator 224. The S→P to vector converters 213A, 213B are similar to a TDL, whereby the output of the S→P to vector converters 213A, 213B indicates the state of the TDL used to generate the signal output by the equalizer filter 110 in FIG. 1.

Each of the 2× chip rate sample data streams 205A, 205B is converted to 1× chip rate length L vectors signals 231A, 231B by the S→P to vector converters 213A, 213B. The length L vectors signals 231A, 231B are then multiplied with a scrambling code conjugate signal 232, (“P”), via the multipliers 214A, 214B, respectively, which each outputs a descrambled vectors signal 234A, 234B to respective vectors accumulators 216A, 216B to generate respective update vectors signals 217A, 217B. The vectors accumulators 216A, 216B implement a despreading operation over periods, (i.e., the same periods as for the chips accumulator 224), that can be other than the spreading factor of the pilot signal received by the antennas 202A and 202B. The update vectors signals 217A, 217B are forwarded to the correction term generators 218A, 218B.

The equalized signals 212A, 212B are summed together by the adder 220 which outputs a summed equalized signal 221. The summed equalized signal 221 is then multiplied with the scrambling code conjugate signal 232, via the multiplier 222, which then outputs a descrambled signal 223. The descrambled signal 223 is fed to the chips accumulator 224, which implements a despreading operation over periods that can be other than the spreading factor of a pilot signal received by the antennas 202A and 202B. The accumulated result signal 225 output by the chips accumulator 224 is subtracted from a pilot reference signal 230 by the adder 226 to generate a joint error signal 227.

Each of the correction term generators 218A, 218B includes a vector norm square estimator, (not shown, but similar to block 116 shown in FIG. 1), for generating a vector norm square of the update vectors signals 217A, 217B and for generating correction terms 219A, 219B based on the update vectors signals 217A, 217B, the vector norm square of the update vectors signals 217A, 217B, and the joint error signal 227 for the equalizer filters 208A, 208B to be added to the filter coefficients of the previous iteration to generate updated filter coefficients for the next iteration.

The correction term generator 218A may generate the correction terms 219A based on the correction term

$${μ}_{P} \cdot {e}_{JOINT} \cdot \frac{{X}_{ud}^{1}}{{‖ {X}_{ud , joint} ‖}^{2}}$$

which is added in the equalizer filter 208A to the filter coefficients of the previous iteration to generate updated filter coefficients for the next iteration. Likewise, the correction term generator 218B may generate the correction terms 219B based on the correction term

$${μ}_{P} \cdot {e}_{joint} \cdot \frac{{X}_{ud}^{2}}{{‖ {X}_{ud , joint} ‖}^{2}}$$

which is added in the equalizer filter 208B to the filter coefficients of the previous iteration to generate updated filter coefficients for the next iteration.

Alternatively, the correction term generator 218A may generate the correction terms 219A based on the correction term

$${μ}_{P} \cdot {e}_{JOINT} \cdot \frac{{X}_{ud}^{1}}{{‖ {X}_{ud , joint} ‖}^{2} + η} ,$$

and the correction term generator 218B may generate the correction terms 219B based on the correction term

$${μ}_{P} \cdot {e}_{joint} \cdot \frac{{X}_{ud}^{2}}{{‖ {X}_{ud , joint} ‖}^{2} + η} .$$

The variable η is a relatively small number that is used to improve the numerical properties and prevent the fixed-point computation from overflow when the correction term is generated.

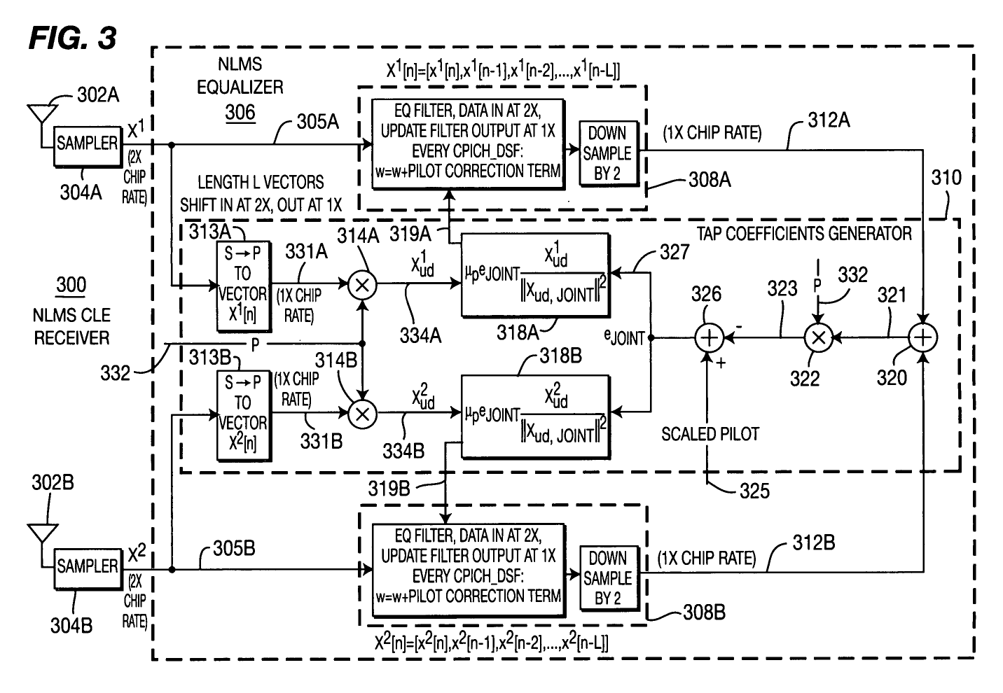

FIG. 3 is a block diagram of a simplified version of the NLMS CLE receiver 200 of FIG. 2. The NLMS CLE receiver 300 is a non-despread pilot-directed joint processing NLMS receiver which uses multiple equalizers. The NLMS CLE receiver 300 includes a plurality of antennas 302A, 302B, a plurality of samplers 304A, 304B and an NLMS equalizer 306. The NLMS equalizer 306 includes a plurality of equalizer filters 308A, 308B and a tap coefficients generator 310. Signals received by the antennas 302A, 302B are respectively input into the samplers 304A, 304B, which generate respective sample data streams 305A, 305B.

Although FIG. 3 illustrates the NLMS CLE receiver 300 as being capable of sampling signals received from two (2) antennas at twice (2×) the chip rate, it should be understood that the NLMS CLE receiver 300 may comprise any number of antennas and equalizer filters, and the signals received by the antennas may be sampled at any desired chip rate.

The NLMS CLE receiver 300 of FIG. 3 is similar to the NLMS CLE receiver 200 shown in FIG. 2 except that the input sample data stream and the outputs from the filter coefficients are not accumulated.

The sample data streams 305A, 305B from the samplers 304A, 304B enter the corresponding equalizer filters 308A, 308B and the tap coefficients generator 310. The sample data streams 305A, 305B are processed and down-sampled, (in this example, down-sampled by 2) by the equalizer filters 308A, 308B to generate equalized signals 312A, 312B at one times (1×) the chip rate.

The tap coefficients generator 310 includes S→P to vector converters 313A, 313B, multipliers 314A, 314B and 322, correction term generators 318A, 318B and adders 320, 326. Each of the sample data streams 305A, 305B is converted to length L vectors signals 331A, 331B by the S→P to vector converters 313A, 313B, which implement a despreading operation over periods that can be other than the spreading factor of a pilot signal received by the antennas 302A and 302B. The length L vectors signals 331A, 331B are then multiplied with the scrambling code conjugate signal 332, (“P”), via the multipliers 314A, 314B, respectively, to generate descrambled vectors signals 334A, 334B. The descrambled vectors signals 334A, 334B are respectively forwarded to the correction term generators 318A, 318B.

The equalized signals 312A, 312B are summed together by the adder 320 which outputs a summed equalized signal 321. The summed equalized signal 321 is then multiplied with a scrambling code conjugate signal 332, (“P”), via the multiplier 322, which then outputs a descrambled signal 323. The descrambled signal 323 is subtracted from a reference pilot, (e.g., scaled pilot), signal 325 by the adder 326 to generate a joint error signal 327.

The correction term generators 318A, 318B are similar to the correction term generators 318A, 318B described in detail above. Each of the correction term generators 318A, 318B includes a vector norm square estimator, (not shown, but similar to block 116 shown in FIG. 1), for generating a vector norm square of the descrambled vectors signals 334A, 334B and for generating correction terms 319A, 319B based on the descrambled vectors 317A, 317B, the vector norm square of the vector norm square of the descrambled vectors signals 334A, 334B, and the joint error signal 327 for the equalizer filters 308A, 308B to be added to the filter coefficients of the previous iteration to generate updated filter coefficients for the next iteration.

The generation of updated filter coefficients used by the NLMS CLE receivers 200 and 300 are as follows:

$$[ \begin{matrix}{\vec{w}}_{n + 1}^{1} \\ {\vec{w}}_{n + 1}^{2}\end{matrix} ] = α \cdot [ \begin{matrix}{\vec{w}}_{n}^{1} \\ {\vec{w}}_{n}^{2}\end{matrix} ] + μ \cdot {e}_{n , joint} \cdot \frac{1}{{‖ {\vec{x}}_{n , joint} ‖}^{2} + ɛ} [ \begin{matrix}{\vec{x}}_{n}^{{1}^{H}} \\ {\vec{x}}_{n}^{{2}^{H}}\end{matrix} ] , \qquad Equation ( 8 )$$

where e_{n,joint} is the joint estimation error resulting from joint processing of two antennas and is defined as follows:
e_{n,joint}=d[n]−(\vec{x}ₙ¹,\vec{w}ₙ¹+\vec{x}ₙ²\vec{w}ₙ²). Equation (9)

A diversity receiver performs the NLMS equalization for each receiving antenna independently as such:
\vec{w}ₙ₊₁ⁱ=α·\vec{w}ₙⁱ+\vec{Δ}ₙⁱ, Equation (10)
where \vec{w}ₙⁱ and \vec{x}ₙⁱ are the tap-weight vector and input update vector of the NLMS equalizer i respectively corresponding to receive antenna i at iteration n. The equalizer i generates the error signal of its own and updates the tap-weight vector independently. The equalizer outputs are despread and combined. For the pilot-directed method, despread data of multiple antennas are soft combined to generate the final output for enhanced performance. For the data-directed method, de-spread data of multiple antennas are soft combined to generate the final output for hard decision and the resulting hard signal is used as reference signal.

Another variation can be obtained if the tap correction terms \vec{Δ}ₙⁱ of Equation (10) are computed by:

$$\begin{matrix}{\vec{Δ}}_{n}^{1} = μ \frac{{\vec{x}}_{n , 1}^{H}}{{‖ {\vec{x}}_{n , 1} ‖}^{2} + ɛ} \cdot {e}_{n , joint} ; \\ and & Equation ( 11 ) \\ {\vec{Δ}}_{n}^{2} = μ \frac{{\vec{x}}_{n , 2}^{H}}{{‖ {\vec{x}}_{n , 2} ‖}^{2} + ɛ} \cdot {e}_{n , joint} . & Equation ( 12 )\end{matrix}$$

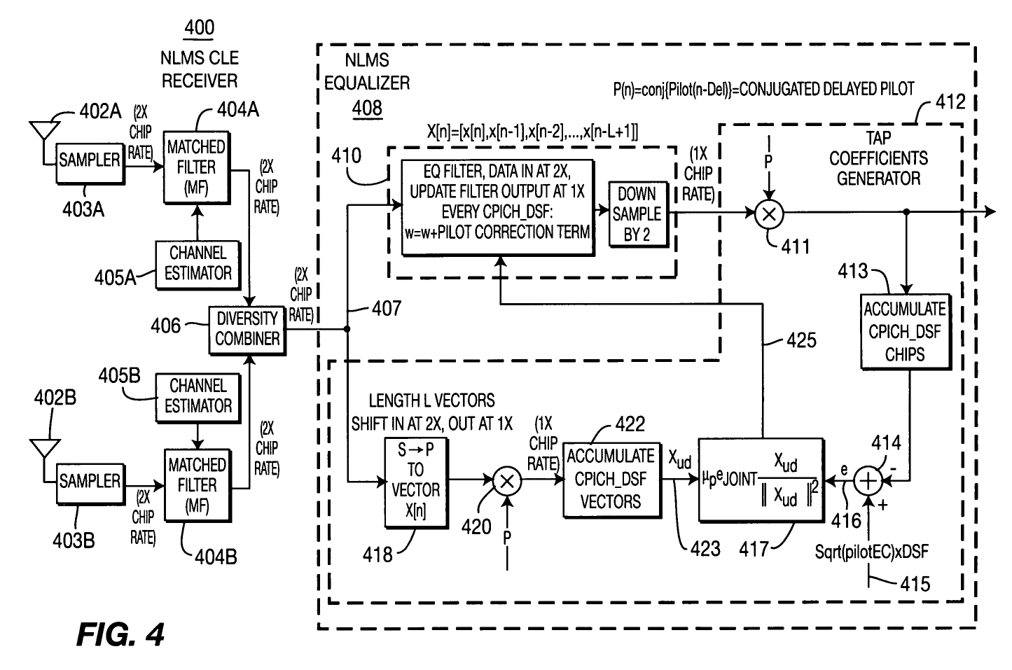

FIG. 4 is a block diagram of an exemplary NLMS CLE receiver 400 configured in accordance with a third embodiment of the present invention. The NLMS CLE receiver 400 uses pre-equalization combining of signals received from the diversity antennas. The NLMS CLE receiver 400 includes a plurality of antennas 402A, 402B, a plurality of samplers 403A, 403B, a plurality of matched filters (MFs) 404A, 404B, a plurality of channel estimators 405A, 405B, a combiner 406 and an NLMS equalizer 408. The NLMS equalizer 408 includes an equalizer filter 410 and a tap coefficients generator 412.

Signals are received by the antennas 402 and sample data streams are generated by the samplers 403 from the received signals. As an example, FIG. 4 illustrates two antennas and sampling at 2× chip rate. However, it should be noted that the receiver 400 may comprise any number of antennas and the samples can be generated at any rate. The samples are processed by the matched filters 404 with channel estimators 405 and combined by the combiner 406 to generate a combined sample data stream 407. The combiner 406 may be a simple adder with or without weighting. Alternatively, a matched filter may be used as the combiner 406 to perform the diversity signal combining. The combined sample data stream 407 remains at the same rate as the sampling rate.

The combined sample data stream 407 is then fed to the equalizer filter 408 and the tap coefficients generator 410. Assuming that two antennas are used, the combined signal can be expressed as follows:
\vec{x}_{n,comb}=H¹^{^{H}}\vec{x}ₙ¹+H²^{^{H}}\vec{x}ₙ², Equation (13)
where Hⁱ is the estimated channel response matrix corresponding to the receive antenna i, where, for the exemplary NLMS CLE receiver 400 which has two antennas, i=1, 2. The vector \vec{x}_{n,comb} is the combined signal vector after the receive diversity combining at the iteration n.

After the diversity combining is performed, a combined sample data stream 407 is generated and forwarded to the equalizer filter 410 and processed to perform equalization to mitigate the interference such as inter-symbol interference (ISI) and multiple access interference (MAI). In this example, the equalizer filter 410 is running at twice (2×) the chip rate and the processed results are down-sampled by 2 to generate a chip rate output, which is then descrambled with a scrambling code sequence.

The NLMS can be described in terms of tap-weight vector updates as follows:

$${\vec{w}}_{n + 1 , comb} = α \cdot {\vec{w}}_{n , comb} + μ \frac{{\vec{x}}_{n , comb}^{H}}{{‖ {x}_{n , comb} ‖}^{2} + ɛ} ( d [ n ] - {\vec{x}}_{n , comb} {\vec{w}}_{n , comb} ) \qquad Equation ( 14 )$$

where \vec{w}_{n,comb} is the tap-weight vector for equalizing the combined receiving signal and d[n] is the reference signal at time n.

The tap coefficients generator 412 includes multipliers 411, 420, a chips accumulator 413, an adder 414, a correction term generator 417, a vectors accumulator 422, a multiplier 420 and an S→P to vector converter 418. The output from the equalizer filter 410 is descrambled via the multiplier 411. The output of the multiplier 411 is accumulated by the chips accumulator 413, which implements a despreading operation over periods that can be other than the spreading factor of a pilot signal received by the antennas 402A and 402B. The accumulated result output by the chips accumulator 413 is subtracted from a pilot reference signal 415 by the adder 414 to generate a joint error signal 416.

The combined data sample stream 407 is converted to length L vectors by the S→P to vector converter 418 and descrambled by the multiplier 420. The descrambled input vectors are accumulated by the vectors accumulator 422 to generate update vectors 423. The vectors accumulator 422 implements a despreading operation over periods, (i.e., the same periods as for the chips accumulator 413), that can be other than the spreading factor of the pilot signal received by the antennas 402A and 402B. The update vectors 423 are forwarded to the correction term generator 417. The correction term generator 417 generates correction terms 425 for the equalizer filter 410 to be added to the filter coefficients of the previous iteration to generate updated filter coefficients for the next iteration.

The correction term generated by the correction term generator 417 is the product of the normalized signal (signal 423 divided by the norm of signal 423) and the error signal 416 and a step size parameter (mu) defined within 417. The new filter values are generated by adding the correction term to the previous filter values. The filter output is an inner product of the filter values and the TDL state vector.

The correction term generator 417 may generate the correction terms 425 based on the correction term

$${μ}_{P} \cdot {e}_{joint} \cdot \frac{{X}_{ud}}{{‖ {X}_{ud} ‖}^{2}}$$

which is added in the equalizer filter 410 to the filter coefficients of the previous iteration to generate updated filter coefficients for the next iteration. Alternatively, the correction term generator 417 may generate the correction terms 425 based on the correction term

$${μ}_{P} \cdot {e}_{joint} \cdot \frac{{X}_{ud}}{{‖ {X}_{ud} ‖}^{2} + η} .$$

The foregoing description of the third embodiment shown in FIG. 4 is related to a despread pilot-directed receiver. Alternatively, the receiver may be a non-despread pilot-directed as shown in FIG. 3. In such a case, no accumulation of the descrambled samples and the received samples streams for generating an update vector need be performed.

Although the features and elements of the present invention are described in particular combinations, each feature or element can be used alone without the other features and elements of the preferred embodiments or in various combinations with or without other features and elements of the present invention.

While the present invention has been described in terms of the preferred embodiment, other variations which are within the scope of the invention will be apparent to those skilled in the art.

What is claimed is:

1. A receiver comprising:
a plurality of antennas for receiving signals;
a plurality of samplers coupled to respective ones of the antennas for generating a plurality of sample data streams, wherein each of the samplers generates a respective sample data stream based on the signals received by a respective one of the antennas;
a multiplexer for merging the sample data streams generated by the samplers into one merged sample data stream; and
an equalizer for processing the merged sample data stream.

2. The receiver of claim 1 wherein the receiver is a code division multiple access (CDMA) receiver in which the sample data streams are sampled at two times a chip rate by the respective samplers, and the merged sample data stream is processed by the equalizer at four times the chip rate.

3. The receiver of claim 1 wherein the equalizer comprises:
an equalizer filter for processing the merged sample stream with filter coefficients; and
a tap coefficients generator for generating at least one filter coefficient correction term for use by the equalizer filter.

4. The receiver of claim 3 wherein the filter coefficient correction term is generated based on a despread pilot sequence.

5. The receiver of claim 3 wherein the filter coefficient correction term is generated based on a non-despread pilot sequence.

6. The receiver of claim 3 wherein the filter coefficient correction term is generated by the tap coefficients generator using a normalized least mean square (NLMS) algorithm.

7. The receiver of claim 3 wherein the tap coefficients generator comprises:
a first multiplier coupled to a first output of the equalizer filter, the first multiplier being configured to receive an equalizer output signal from the first output of the equalizer filter and multiply the equalizer output signal with a scrambling code conjugate signal to generate a descrambled equalizer output signal;
a second multiplier coupled to a second output of the equalizer filter, the second multiplier being configured to receive an equalizer tapped delay line (TDL) signal from the second output of the equalizer filter and multiply the equalizer TDL signal with the scrambling code conjugate signal to generate a vector signal having a value X;
an adder for subtracting the first descrambled signal from a pilot reference signal to generate an error signal;
a vector norm square estimator for receiving the vector signal and generating a signal having a value which is equal to ∥X∥²; and
a taps correction unit which generates a vector signal representing tap values used by the equalizer filter to generate the equalizer output signal and the equalizer TDL signal.

8. A receiver comprising:
a plurality of antennas for receiving signals;
a plurality of samplers coupled to respective ones of the antennas for generating a plurality of sample data streams, wherein each of the samplers generates a respective sample data stream based on the signals received by a respective one of the antennas; and
an equalizer for processing the sample data streams.

9. The receiver of claim 8 wherein the receiver is a code division multiple access (CDMA) receiver in which the sample data streams are sampled at two times a chip rate by the respective samplers.

10. The receiver of claim 8 wherein the equalizer comprises:
a plurality of equalizer filters coupled to respective ones of the samplers for processing the sample data streams using filter coefficients; and
a tap coefficients generator for generating at least one filter coefficient correction term for use by the equalizer filters.

11. The receiver of claim 10 wherein the receiver is a code division multiple access (CDMA) receiver in which the sample data streams are sampled at two times a chip rate by the respective samplers and are down-sampled to chip rate by the respective equalizer filters.

12. The receiver of claim 10 wherein the filter coefficient correction term is generated based on a despread pilot sequence.

13. The receiver of claim 10 wherein the filter coefficient correction term is generated based on a non-despread pilot sequence.

14. The receiver of claim 10 wherein the filter coefficient correction term is generated by the tap coefficients generator using a normalized least mean square (NLMS) algorithm.

15. The receiver of claim 10 wherein the tap coefficients generator comprises:
a plurality of serial-to-parallel (S→P) to vector converters coupled to respective ones of the samplers and equalizer filters for converting each respective sample data stream to a length L vectors signal;
a plurality of vector descrambling multipliers coupled to respective ones of the S→P to vector converters, each vector descrambling multiplier being configured to multiply the length L vectors signal output by a respective S→P to vector converter with a scrambling code conjugate signal to generate a descrambled vectors signal;
a first adder coupled to each of the equalizer filters for adding an equalized output signal generated by each of the equalizer filters to generate a summed equalizer output signal;
an equalizer output multiplier coupled to the adder for multiplying the summed equalizer output signal with the scrambling code conjugate signal to generate a descrambled summed equalizer signal;
a second adder for subtracting the descrambled summed equalizer signal from a pilot reference signal to generate a joint error signal; and
a plurality of correction term generators coupled to the adder, a respective one of the vector descrambling multipliers and a respective one of the equalizer filters, wherein each of the correction term generators outputs correction terms for use by a respective one of the equalizer filters based on the joint error signal and a respective descrambled vectors signal generated by a respective vector descrambling multiplier.

16. The receiver of claim 15 wherein the tap coefficients generator further comprises:
a plurality of vectors accumulators coupled between respective ones of the vector descrambling multipliers and respective ones of the correction term generators; and
a chips accumulator coupled between the equalizer output multiplier and the second adder.

17. A receiver comprising:
a plurality of antennas for receiving signals;
a plurality of samplers coupled to respective ones of the antennas for generating a plurality of sample data streams, wherein each of the samplers generates a respective sample data stream based on the signals received by a respective one of the antennas;
a plurality of channel estimators for estimating a channel impulse response;
a plurality of matched filters (MFs) coupled to respective ones of the samplers and the MFs for processing the sample data streams in accordance with the estimated channel impulse response;
a combiner for combining outputs from the MFs; and
an equalizer for processing the combined outputs of the MFs.

18. The receiver of claim 17 wherein the receiver is a code division multiple access (CDMA) receiver in which the sample data streams are sampled at two times a chip rate by the respective samplers.

19. The receiver of claim 17 wherein the combiner combines a plurality of multipath components of the signals received by the antennas.

20. The receiver of claim 17 wherein the equalizer comprises:
an equalizer filter for processing the combined outputs of the MFs using filter coefficients; and
a tap coefficients generator for generating at least one filter coefficient correction term for use by the equalizer filter.

21. The receiver of claim 17 wherein the receiver is a code division multiple access (CDMA) receiver in which the sample data streams are sampled at two times a chip rate by the respective samplers and are down-sampled to chip rate by the equalizer filter.

22. The receiver of claim 20 wherein the filter coefficient correction term is generated based on a despread pilot sequence.

23. The receiver of claim 20 wherein the filter coefficient correction term is generated based on a non-despread pilot sequence.

24. The receiver of claim 15 wherein the filter coefficient correction term is generated by the tap coefficients generator using a normalized least mean square (NLMS) algorithm.

25. The receiver of claim 20 wherein the tap coefficients generator comprises:
a serial-to-parallel (S→P) to vector converter coupled to the combiner and the equalizer filter for converting the combined outputs of the MFs to a length L vectors signal;
a vector descrambling multiplier coupled to the S→P to vector converter for multiplying the length L vectors signal output by the S→P to vector converter with a scrambling code conjugate signal to generate a descrambled vectors signal;
an equalizer output multiplier coupled to the equalizer filter for multiplying an equalizer output signal generated by the equalizer filter with a scrambling code conjugate signal to generate a descrambled equalizer signal;
an adder for subtracting the descrambled equalizer signal from a pilot reference signal to generate an error signal; and
a correction term generator coupled to the adder, the vector descrambling multiplier and the equalizer filters, wherein the correction term generator outputs correction terms for use by the equalizer filter based on the error signal and the descrambled vectors signal generated by the vector descrambling multiplier.

26. The receiver of claim 25 wherein the tap coefficients generator further comprises:
a vectors accumulator coupled between the vector descrambling multiplier and the correction term generator; and
a chips accumulator coupled between the equalizer output multiplier and the adder.

27. An integrated circuit (IC) used in conjunction with a receiver having a plurality of antennas for receiving signals, the IC comprising:
a plurality of samplers coupled to respective ones of the antennas for generating a plurality of sample data streams, wherein each of the samplers generates a respective sample data stream based on the signals received by a respective one of the antennas;
a multiplexer for merging the sample data streams generated by the samplers into one merged sample data stream; and
an equalizer for processing the merged sample data stream.

28. The IC of claim 27 wherein the receiver is a code division multiple access (CDMA) receiver, the sample data streams are sampled at two times a chip rate by the respective samplers, and the merged sample data stream is processed by the equalizer at four times the chip rate.

29. The IC of claim 27 wherein the equalizer comprises:
an equalizer filter for processing the merged sample stream with filter coefficients; and
a tap coefficients generator for generating at least one filter coefficient correction term for use by the equalizer filter.

30. The IC of claim 29 wherein the filter coefficient correction term is generated based on a despread pilot sequence.

31. The IC of claim 29 wherein the filter coefficient correction term is generated based on a non-despread pilot sequence.

32. The IC of claim 29 wherein the filter coefficient correction term is generated by the tap coefficients generator using a normalized least mean square (NLMS) algorithm.

33. The IC of claim 29 wherein the tap coefficients generator comprises:
a first multiplier coupled to a first output of the equalizer filter, the first multiplier being configured to receive an equalizer output signal from the first output of the equalizer filter and multiply the equalizer output signal with a scrambling code conjugate signal to generate a descrambled equalizer output signal;
a second multiplier coupled to a second output of the equalizer filter, the second multiplier being configured to receive an equalizer tapped delay line (TDL) signal from the second output of the equalizer filter and multiply the equalizer TDL signal with the scrambling code conjugate signal to generate a vector signal having a value X;
an adder for subtracting the first descrambled signal from a pilot reference signal to generate an error signal;
a vector norm square estimator for receiving the vector signal and generating a signal having a value which is equal to ∥X∥²; and
a taps correction unit which generates a vector signal representing tap values used by the equalizer filter to generate the equalizer output signal and the equalizer TDL signal.

34. An integrated circuit (IC) used in conjunction with a receiver having a plurality of antennas for receiving signals, the IC comprising:
a plurality of samplers coupled to respective ones of the antennas for generating a plurality of sample data streams, wherein each of the samplers generates a respective sample data stream based on the signals received by a respective one of the antennas; and
an equalizer for processing the sample data streams.

35. The IC of claim 34 wherein the receiver is a code division multiple access (CDMA) receiver and the sample data streams are sampled at two times a chip rate by the respective samplers.

36. The IC of claim 34 wherein the equalizer comprises:
a plurality of equalizer filters coupled to respective ones of the samplers for processing the sample data streams using filter coefficients; and
a tap coefficients generator for generating at least one filter coefficient correction term for use by the equalizer filters.

37. The IC of claim 36 wherein the receiver is a code division multiple access (CDMA) receiver and the sample data streams are sampled at two times a chip rate by the respective samplers and are down-sampled to chip rate by the respective equalizer filters.

38. The IC of claim 36 wherein the filter coefficient correction term is generated based on a despread pilot sequence.

39. The IC of claim 36 wherein the filter coefficient correction term is generated based on a non-despread pilot sequence.

40. The IC of claim 36 wherein the filter coefficient correction term is generated by the tap coefficients generator using a normalized least mean square (NLMS) algorithm.

41. The IC of claim 36 wherein the tap coefficients generator comprises:
a plurality of serial-to-parallel (S→P) to vector converters coupled to respective ones of the samplers and equalizer filters for converting each respective sample data stream to a length L vectors signal;
a plurality of vector descrambling multipliers coupled to respective ones of the S→P to vector converters, each vector descrambling multiplier being configured to multiply the length L vectors signal output by a respective S→P to vector converter with a scrambling code conjugate signal to generate a descrambled vectors signal;
a first adder coupled to each of the equalizer filters for adding an equalized output signal generated by each of the equalizer filters to generate a summed equalizer output signal;
an equalizer output multiplier coupled to the adder for multiplying the summed equalizer output signal with the scrambling code conjugate signal to generate a descrambled summed equalizer signal;
a second adder for subtracting the descrambled summed equalizer signal from a pilot reference signal to generate a joint error signal; and
a plurality of correction term generators coupled to the adder, a respective one of the vector descrambling multipliers and a respective one of the equalizer filters, wherein each of the correction term generators outputs correction terms for use by a respective one of the equalizer filters based on the joint error signal and a respective descrambled vectors signal generated by a respective vector descrambling multiplier.

42. The IC of claim 41 wherein the tap coefficients generator further comprises:
a plurality of vectors accumulators coupled between respective ones of the vector descrambling multipliers and respective ones of the correction term generators; and
a chips accumulator coupled between the equalizer output multiplier and the second adder.

43. An integrated circuit (IC) used in conjunction with a receiver having a plurality of antennas for receiving signals, the IC comprising:
a plurality of samplers coupled to respective ones of the antennas for generating a plurality of sample data streams, wherein each of the samplers generates a respective sample data stream based on the signals received by a respective one of the antennas;
a plurality of channel estimators for estimating a channel impulse response;
a plurality of matched filters (MFs) coupled to respective ones of the samplers and the MFs for processing the sample data streams in accordance with the estimated channel impulse response;
a combiner for combining outputs from the MFs; and
an equalizer for processing the combined outputs of the MFs.

44. The IC of claim 43 wherein the receiver is a code division multiple access (CDMA) receiver and the sample data streams are sampled at two times a chip rate by the respective samplers.

45. The IC of claim 43 wherein the combiner combines a plurality of multipath components of the signals received by the antennas.

46. The IC of claim 43 wherein the equalizer comprises:
an equalizer filter for processing the combined outputs of the MFs using filter coefficients; and
a tap coefficients generator for generating at least one filter coefficient correction term for use by the equalizer filter.

47. The IC of claim 43 wherein the receiver is a code division multiple access (CDMA) receiver in which the sample data streams are sampled at two times a chip rate by the respective samplers and are down-sampled to chip rate by the equalizer filter.

48. The IC of claim 46 wherein the filter coefficient correction term is generated based on a despread pilot sequence.

49. The IC of claim 46 wherein the filter coefficient correction term is generated based on a non-despread pilot sequence.

50. The IC of claim 46 wherein the filter coefficient correction term is generated by the tap coefficients generator using a normalized least mean square (NLMS) algorithm.

51. The IC of claim 46 wherein the tap coefficients generator comprises:
a serial-to-parallel (S→P) to vector converter coupled to the combiner and the equalizer filter for converting the combined outputs of the MFs to a length L vectors signal;
a vector descrambling multiplier coupled to the S→P to vector converter for multiplying the length L vectors signal output by the S→P to vector converter with a scrambling code conjugate signal to generate a descrambled vectors signal;
an equalizer output multiplier coupled to the equalizer filter for multiplying an equalizer output signal generated by the equalizer filter with a scrambling code conjugate signal to generate a descrambled equalizer signal;
an adder for subtracting the descrambled equalizer signal from a pilot reference signal to generate an error signal; and
a correction term generator coupled to the adder, the vector descrambling multiplier and the equalizer filters, wherein the correction term generator outputs correction terms for use by the equalizer filter based on the error signal and the descrambled vectors signal generated by the vector descrambling multiplier.

52. The IC of claim 51 wherein the tap coefficients generator further comprises:
a vectors accumulator coupled between the vector descrambling multiplier and the correction term generator; and
a chips accumulator coupled between the equalizer output multiplier and the adder.

53. A method of processing signals received from a plurality of antennas, the method comprising:
(a) generating a plurality of sample data streams, wherein each of sample data stream is based on the signals received by a respective one of the antennas;
(b) merging the sample data streams into one merged sample data stream; and
(c) processing the merged sample data stream.

54. The method of claim 53 wherein a code division multiple access (CDMA) receiver is used to perform steps (a)-(c), the method further comprising:
(d) sampling the sample data streams at two times a chip rate; and
(e) processing the merged sample data stream at four times the chip rate.

55. The method of claim 53 further comprising:
(d) processing the merged sample stream with filter coefficients; and
(e) generating at least one filter coefficient correction term.

56. The method of claim 55 wherein the filter coefficient correction term is generated based on a despread pilot sequence.

57. The method of claim 55 wherein the filter coefficient correction term is generated based on a non-despread pilot sequence.

58. The method of claim 55 wherein the filter coefficient correction term is generated using a normalized least mean square (NLMS) algorithm.

59. The method of claim 55 further comprises:
(f) receiving an equalized output signal and multiplying the equalized output signal with a scrambling code conjugate signal to generate a descrambled equalized output signal;
(g) receiving an equalizer tapped delay line (TDL) signal and multiplying the equalizer TDL signal with the scrambling code conjugate signal to generate a vector signal having a value X;
(h) subtracting the first descrambled signal from a pilot reference signal to generate an error signal;
(i) generating a signal having a value which is equal to ∥X∥² based on the vector signal; and
(j) generating a vector signal representing tap values used to generate the equalized output signal and the equalizer TDL signal.

60. A method of processing signals received from a plurality of antennas, the method comprising:
(a) generating a plurality of sample data streams, wherein each of sample data stream is based on the signals received by a respective one of the antennas; and
(b) processing the sample data streams.

61. The method of claim 60 wherein a code division multiple access (CDMA) receiver is used to perform steps (a) and (b), the method further comprising:
(c) sampling the sample data streams at two times a chip rate.

62. The method of claim 60 further comprising:
(c) processing the sample data streams using filter coefficients; and
(d) generating at least one filter coefficient correction term.

63. The method of claim 60 wherein a code division multiple access (CDMA) receiver is used to perform steps (a)-(d), the method further comprising:
(e) sampling the sample data streams at two times a chip rate; and
(f) down-sampling the sample data streams to chip rate.

64. The method of claim 62 wherein the filter coefficient correction term is generated based on a despread pilot sequence.

65. The method of claim 62 wherein the filter coefficient correction term is generated based on a non-despread pilot sequence.

66. The method of claim 62 wherein the filter coefficient correction term is generated using a normalized least mean square (NLMS) algorithm.

67. The method of claim 62 further comprising:
(e) converting each respective sample data stream to a length L vectors signal;
(f) multiplying each length L vectors signal with a scrambling code conjugate signal to generate a respective descrambled vectors signal;
(g) adding a plurality of equalized output signals to generate a summed equalizer output signal;
(h) multiplying the summed equalizer output signal with the scrambling code conjugate signal to generate a descrambled summed equalizer signal;
(i) subtracting the descrambled summed equalizer signal from a pilot reference signal to generate a joint error signal; and
(j) generating correction terms based on the joint error signal and a respective descrambled vectors signal.

68. A method of processing signals received from a plurality of antennas, the method comprising:
(a) generating a plurality of sample data streams, wherein each of sample data stream is based on the signals received by a respective one of the antennas;
(b) estimating a channel impulse response;
(c) processing the sample data streams in accordance with the estimated channel impulse response to generate a plurality of processed signals;
(d) combining the processed signals; and
(e) processing the combined processed signals.

69. The method of claim 68 wherein a code division multiple access (CDMA) receiver is used to perform steps (a)-(e), the method further comprising:
(f) sampling the sample data streams at two times a chip rate.

70. The method of claim 68 wherein step (d) comprises combining a plurality of multipath components of the signals received by the antennas.

71. The method of claim 68 further comprising:
(f) processing the combined processed signals using filter coefficients; and
(g) generating at least one filter coefficient correction term.

72. The method of claim 68 wherein a code division multiple access (CDMA) receiver is used to perform steps (a)-(e), the method further comprising:
(f) sampling the sample data streams at two times a chip rate; and
(g) down-sampling the sample data streams to chip rate.

73. The method of claim 71 wherein the filter coefficient correction term is generated based on a despread pilot sequence.

74. The method of claim 71 wherein the filter coefficient correction term is generated based on a non-despread pilot sequence.

75. The method of claim 71 wherein the filter coefficient correction term is generated using a normalized least mean square (NLMS) algorithm.

76. The method of claim 71 further comprising:
(h) converting the combined processed signals to a length L vectors signal;
(i) multiplying the length L vectors signal output by the S→P to vector converter with a scrambling code conjugate signal to generate a descrambled vectors signal;
(j) multiplying an equalized output signal with a scrambling code conjugate signal to generate a descrambled equalizer signal;
(k) subtracting the descrambled equalizer signal from a pilot reference signal to generate an error signal; and
(l) generating correction terms based on the error signal and the descrambled vectors signal.
